(19) United States
(12) Patent Application Publication
(10) Pub. No.: US 2026/0371110 A1
(43) Pub. Date: Nov. 19, 2026

(54) CONFIGURATION DETERMINATION FOR A WIRELESS SITE BY AN ARTIFICIAL INTELLIGENCE SYSTEM

(71) Applicant: T-Mobile USA, Inc., Bellevue, WA (US)

(72) Inventors: Emile Minh Tran, Sammamish, WA (US); Robert Andrew Berrier, Renton, WA (US); Antoine T. Tran, Bellevue, WA (US); Oussama Akhdari, Issaquah, WA (US); Cody Heinrich, Gardner, KS (US)

(21) Appl. No.: 19/210,915

(22) Filed: May 16, 2025

(51) Int. Cl. H04W 24/02; H04L 41/16; H04W 16/22

(52) U.S. Cl. CPC H04W 24/02; H04L 41/16; H04W 16/22

(57) ABSTRACT

Techniques for configuring a network of a telecommunications system are described herein. A computing device can implement a model to determine settings or parameters of a network element (or equipment thereof). The model can receive current hardware spectrum data, spectrum profile data requesting a change of spectrum, and rules for various equipment for providing radio access to user equipment using the network element. The computing device can analyze the data to determine a configuration of the network element (e.g., wiring information, equipment required, baseband configuration(s), etc.) that optimizes computational resources available to the network element.

### BACKGROUND

Modern terrestrial telecommunication systems include heterogeneous mixtures of second, third, and fourth generation (2G, 3G, and 4G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies. Telecommunications systems may include fifth generation (5G) cellular-wireless access technologies to provide improved bandwidth and decreased response times to a multitude of devices that may be connected to a network.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 an example network environment in which an example network element management system configures a network element of a telecommunications system for exchanging data with user equipment.

FIG. 2 depicts an example system architecture for a fifth generation (5G) telecommunication network.

FIG. 3 depicts a block diagram of an example network element management system to implement the techniques described herein.

FIG. 4 depicts another block diagram of an example network element management system to implement the techniques described herein.

FIG. 5 depicts a flowchart of an example process for determining a configuration for an example network element by an example network element management system.

FIG. 6 depicts an example system architecture for a user equipment.

### DETAILED DESCRIPTION

This application relates to techniques for configuring a network element of a telecommunications system. For example, a network element management system can determine configurations for various network elements (e.g., a cell site, a base station, a transceiver, or the like) of the telecommunications system. The network element management system can represent an artificial intelligence (AI) system such as a machine learning model, an expert system, or the like. The network element management system can, for instance, determine settings or parameters for a network element (or equipment thereof) that optimizes computational resources available to the network element (e.g., available power, memory, processor resources, etc.). The techniques can enable network element configurations to be generated in less time and with more accuracy versus relying on a human to design and build new spectrum for the network element. The network element management system can, for example, add or remove spectrum for cell sites by outputting configurations that optimize available equipment to provide a network for user equipment to exchange data.

In some examples, the network element management system (also referred to herein as “the system”) can receive input data such as hardware spectrum data indicating current hardware available at the network element, spectrum profile data requesting a change of spectrum, and/or rules for arranging and connecting various types of equipment that collectively provide radio access to user equipment using the network element. The network element management system can analyze the input data to determine a configuration of the network element (e.g., wiring information, equipment required, baseband configuration(s), etc.).

In various examples, the network element management system can receive a request to update multiple network elements to provide a new spectrum to the UE(s) accessing the network elements. For instance, the telecommunications system can include thousands or more network elements (e.g., cell sites) for adding the new spectrum, and the network element management system can generate output data specific for each of the multiple network elements (e.g., configuration data based on rules unique for the frequency band, baseband units, or other equipment at the respective network elements).

In some examples, the network element management system can generate the output data independent of requiring input from a user interface or from a user thereof (e.g., does not require human experts of the telecommunications system to identify an optimal configuration). The network element management system can include a model or component that automatically generates one or more configurations for each network element based on capabilities, limitations, and/or requirements of hardware, firmware, and/or software available to the network element. For example, a configuration can specify which frequency bands to provide using a particular baseband unit and identify wiring that minimizes or eliminates a need to dispatch a technician to the network element to implement the configuration thereby saving operational costs.

The techniques can optimize availability of computational resources (e.g., power, memory, and/or processor resources) for a network element by determining settings, parameters, equipment requirements, wiring schematics, and so on for the network element to add or remove spectrum. In some examples, the system can store information from a human expert of the telecommunications system in a database and apply the “human knowledge” without requiring input from a user. In other examples the system can output a candidate configuration (e.g., an intermediate output) to a user interface or model and receive an input validating or verifying the candidate configuration as a final configuration for use by the network element.

The techniques can improve a telecommunications network by determining candidate configurations that limit a number of wiring changes and/or provide wiring instructions for automatic implementation (e.g., using a remote control switch) while also improving overall network capacity, power usage (e.g., lowers transmission power), quality of service, latency, etc. (e.g., by the network element). The techniques may also include the system selecting an optimal configuration from a set of candidate configurations based on criteria such as operation cost, timing, wiring complexity, etc.

A computing device can manage changes to the network element based on receiving rules, hardware information, spectrum profiles, or the like and determine parameters for one or more network elements to exchange data with user equipment. In some examples, the parameters of the network element can represent one or more of: downlink power, uplink power, number of downlink transmitters, number of uplink transmitters, numbers of concurrently connected users, a cell radius, a number of sectors, and so on.

In some examples, the network element can represent a base station (e.g., a gNodeB (gNB)), a transceiver, an antenna, a relay point, an access point, a serving node, a computing device (e.g., a server), or other entity of the telecommunications network. The techniques described herein can be used to control spectrums provided by network elements that may be accessed by a device. For instance, the network element management system of a computing device can optimize settings or parameters for a network element (e.g., a new cell site, a change to an existing cell site, etc.).

As mentioned, the techniques described herein can improve a computing device and/or network in a variety of ways. Quality of service, network bandwidth, etc. can be improved by managing configurations for one or more network elements with consideration to rules for integrating the various types of equipment. For instance, the techniques may improve availability of computational resources (e.g., network elements, processing resources, memory resources, and the like) to the telecommunications network by limiting use of processor, memory, and/or power resources available to the telecommunications network.

Though some examples are described in relation to a computing device, in various examples one or more computing devices, UEs, networks, or other entities may perform or otherwise be associated with the techniques described herein. In various examples, a device may be configured with instructions to implement the techniques described herein. For example, the device can be configured with the instructions to cause the device to design, build, and maintain a particular network element.

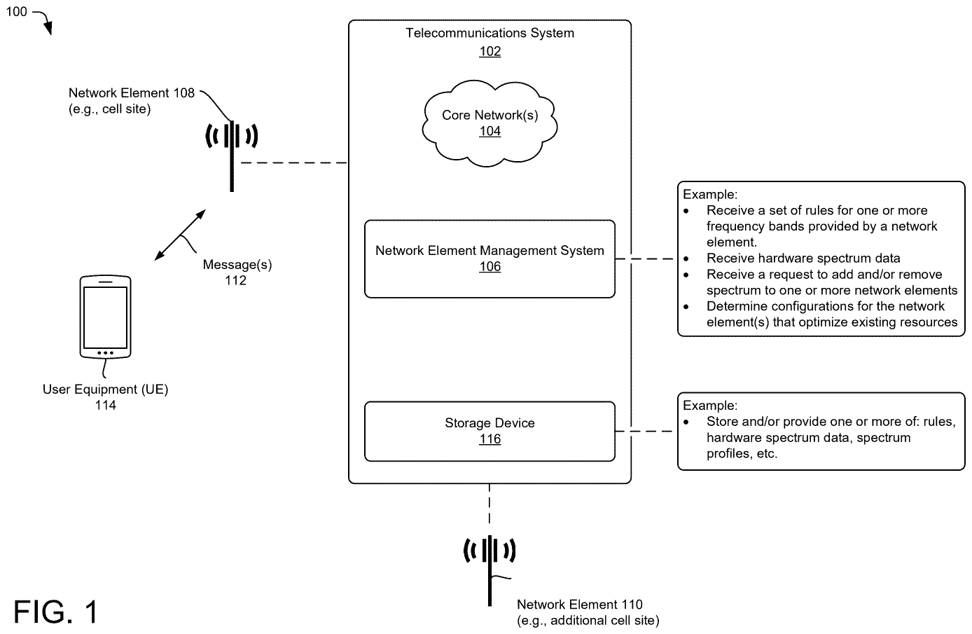

FIG. 1 an example network environment 100 in which an example network element management system configures a network element of a telecommunications system for exchanging data with an example user equipment. As shown in FIG. 1, the telecommunications system 102 includes one or more core networks 104 (may also be referred to as the core network 104 or the core network(s) 104) for exchanging data and a network element management system 106 that is configured to determine configurations network elements of the core network(s) 104. In various examples, the core network(s) 104 can include a network element 108 (e.g., a first cell site) and/or a network element 110 (e.g., a second cell site), though any number of network elements may be included depending on examples.

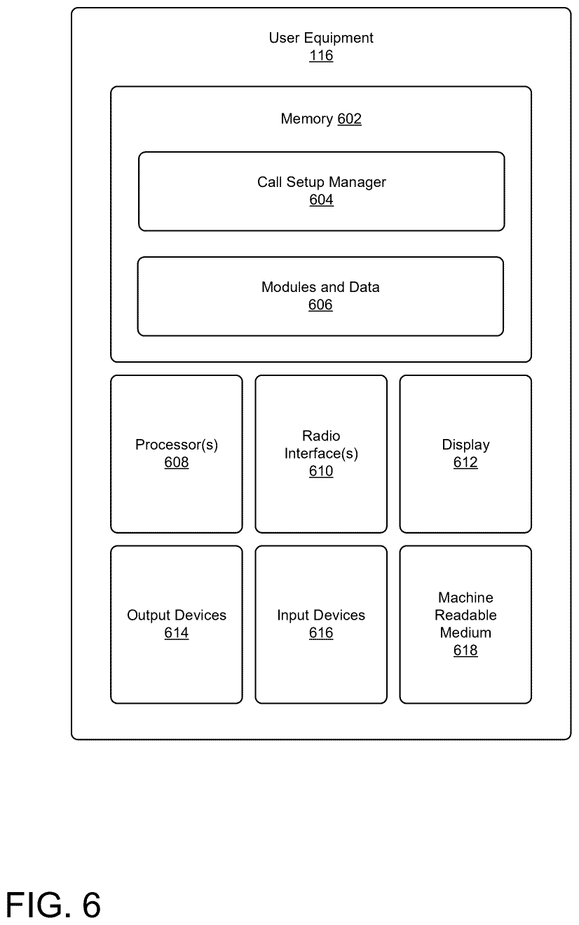

In some examples, the telecommunications system 102 can exchange one or more messages 112 (may also be referred to as the message 112 or the message(s) 112) with a user equipment (UE) 114 using the core network(s) 104. An example architecture for the UE 114 is illustrated in greater detail in FIG. 6. FIG. 1 also shows the telecommunications system 102 comprising a storage device 116 for storing and/or providing data associated with an input and/or an output of the network element management system 106.

Though user equipment is shown in FIG. 1 for example purposes, other device types may also or instead be included in examples. For instance, the techniques described herein can be used to configure a network element for access by any device that can wirelessly connect to the network element, and in some examples may include a mobile phone, a sensor, a personal digital assistant (PDA), a personal computer (PC) such as a laptop, desktop, or workstation, a media player, a tablet, a gaming device, an access point, a relay point, a smart watch, a hotspot, a Machine to Machine device (M2M), a vehicle (e.g., an autonomous vehicle, an unmanned aerial vehicle, airplane, boat, etc.), an Internet of Things (IoT) device, a wearable device, a vehicle, an unmanned aerial vehicle (UAV), or any other type of computing or communication device.

The core network 104 can, for example, represent a 5G network though other core network types may also be used (e.g., past or future generation networks such as a sixth generation (6G) network). The core network 104 can be made up of one or more network elements, such as the network element 108 and the network element 110.

The network element management system 106 may represent firmware, hardware and/or software that generates, outputs, selects, or otherwise determines configuration data for the network element 108, the network element 110, or other network element of the telecommunications system 102. The network element management system 106 may, for example, receive a variety of input data such as one or more of: a set of rules for one or more frequency bands provided by a network element, hardware spectrum data indicating historical, current, and/or predicted hardware usable by the network element, and spectrum profile data for one or more spectrum profiles, to name a few. The network element management system 106 can, for example, determine output data representing various configurations for operating the one or more network elements based on the input data.

In some examples, the network element management system 106 can receive, as some of the input data, data from an interface associated with a cell site designer, a cell site builder, and/or an operational user responsible for operating costs of the network element. For example, data from the interface can indicate a rule for designing, building, and/or operating various network elements. Additionally, or alternatively, the network element management system 106 can receive at least some of the input data from a model such has a machine learning model that is trained to generate an architecture rule, an operating rule, and/or a rule for building a particular network element.

In various examples, the network element 108 or the network element 110 can represent a base station (e.g., a gNB), a transceiver, an antenna, a relay point, an access point, a serving node, a computing device (e.g., a server), just to name a few. In some examples, the network element management system 106 can select an optimal configuration from a set of candidate configurations for the respective network element to exchange data with the UE 114 as part of the core network(s) 104.

By way of example and not limitation, the network element management system 106 can receive an indication to add spectrum to the network element 108 and determine a configuration (e.g., settings, parameters, equipment architecture, etc.) for the network element 108 that optimizes power, memory, and/or processing resources at the network element 108. In some examples, the network element management system 106 can receive inventory information for the network element 108 and determine output data representing instructions for wiring between equipment (e.g., radios, basebands, etc.) of the network element 108 based on rules associated with the inventory. For example, the network element management system 106 can minimize an amount of wiring to add the spectrum optimize the use of frequency bands assigned to various baseband units. For instance, the output data can indicate assignments for frequency blocks to specific portions of one or more basebands, or central equipment of the network element.

By using the techniques described herein, the network element 108 can exchange data as the message(s) 112 with the UE 114. In some examples, the message(s) 112 may be associated with a request to place a call, access a service, or otherwise connect to the telecommunications system 102. The message 112 may, for example, represent a communication between the UE 114 and another UE. The network element management system 106 can determine configurations for the network element 108 to satisfy requests for a change in spectrum over time.

The storage device 116 can represent a database, memory, or other storage device for storing and/or providing rules, hardware spectrum data, spectrum profiles, etc. For instance, the storage device 116 can receive a rule from a user interface and/or from a model that indicates a requirement, a capability, or a limitation of the network element. The rule can indicate, for example, a limitation of a radio such as watts per MHz, watts per transmission channel, watts per band, total watts, etc. The rule may also or instead indicate a number of frequency blocks for a particular band, a network element type (e.g., a type of cell site), technology used at the cell site, a maximum number of cells, a number of sectors, and/or limits for various types of equipment. The storage device 116 can, for example, store data output by the system 106 such as a bill of materials, equipment to upgrade, wiring instructions, frequency band(s) assigned to respective baseband units, and so on.

In some examples, the techniques can include optimizing network performance by automatically determining configuration data for the network element 108 to enable data exchanges with the UE 114. In some examples, the network element management system 106 can lower an amount of time to design, build, and/or maintain a cell site while making efficient use of equipment currently at the cell site. The techniques enable adding new spectrum to a cell site in less time and with the fewest wiring or equipment changes by using a system that identifies configuration data that optimally connects existing and/or new equipment while also meeting operational criteria (e.g., a cost, a minimal performance level, etc.) or satisfying other rules.

In various examples, the network element management system 106 can transmit at least some of the output data to the network element 108 to change a parameter, setting, etc. of the network element 108. In some examples, the change in parameter, setting, etc. can cause the network element 108 to change power output, tilt angle, a number of carriers, a frequency band, and/or a number of sectors, to name a few. In some examples, the output data can be used to control operation of the network element 108 to utilize existing equipment, power capacity, etc. to design the network element for a change in the spectrum.

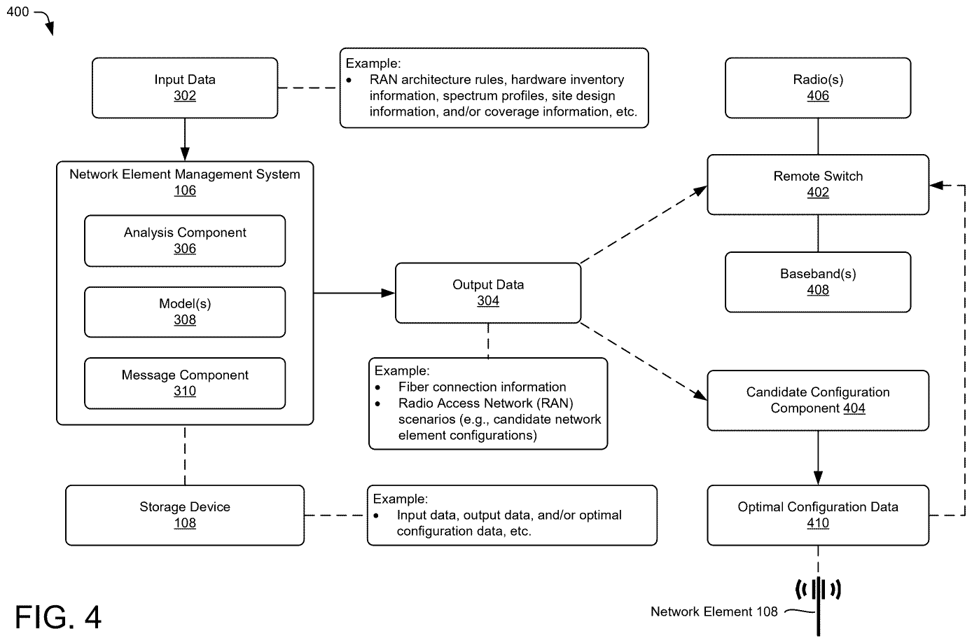

Output data from the network element management system 106 can be used to optimize power, processor, and/or memory resources. The output data can include multiple configurations for a single network element, and a component of the system 106 (e.g., the candidate configuration component 404 of FIG. 4) can select an optimal configuration from among the multiple candidate configurations output by the system. For example, the system 106 can select one of the candidate configurations as the optimal configuration for transmitting to the network element 108 to cause a change in operation of the network element 108.

To implement the techniques described herein, in various examples the telecommunications system 102 and/or the network element management system 106 can include one or more of: an a proxy call session control function (P-CSCF), an interrogating call session control function (ICSCF), a serving call session control function (SCSCF), a serving gateway (SGW), a packet data network gateway (PGW), a policy and charging rules function (PCRF), and an internet protocol short message gateway (IPSM-GW), a short message service center (SMSC), and an evolved packet data gateway (ePDG), and a Home Subscriber Server (HSS), just to name a few. In addition, the techniques described herein may be implemented using Real-Time Protocol (RTP) and/or Real-Time Control Protocol (RTCP), among others.

In various examples, the telecommunications system 102 (e.g., a 5G system) can represent functionality to provide a communication channel for the UE 114 and can include one or more radio access networks (RANs), as well as one or more core networks linked to the RANs. For instance, the UE 114 can wirelessly connect to a base station or other access point of a RAN, and in turn be connected to the core network (e.g., a 5G core network). The RANs and/or core networks can be compatible with one or more radio access technologies, wireless access technologies, protocols, and/or standards. For example, wireless and radio access technologies can include fifth generation (5G) technology, Long Term Evolution (LTE)/LTE Advanced technology, other fourth generation (4G) technology, third generation (3G) technology, High-Speed Data Packet Access (HSDPA)/Evolved High-Speed Packet Access (HSPA+) technology, Universal Mobile Telecommunications System (UMTS) technology, Global System for Mobile Communications (GSM) technology, WiFi technology, and/or any other previous or future generation of radio access technology. In this way, the telecommunications system 102 is compatible to operate with other radio technologies including those of other service providers. Accordingly, the message(s) 112 associated with the UE 114 may originate with another service provider (e.g., a third-party) and be processed by the network element management system 106 independent of the technolog(ies) or core network associated with the service provider.

In some examples, the network element management system 106 can be included in or otherwise represent a computing device that determines configurations for a network element based on pre-determined rules, existing equipment, and the type of frequencies being added or removed. Limitations of RAN architecture typically understood by a human expert can be considered by the system 106 to cause the network element 108 to wirelessly connect using the configuration (e.g., power control settings, a number of carriers, a number of frequency bands, etc.).

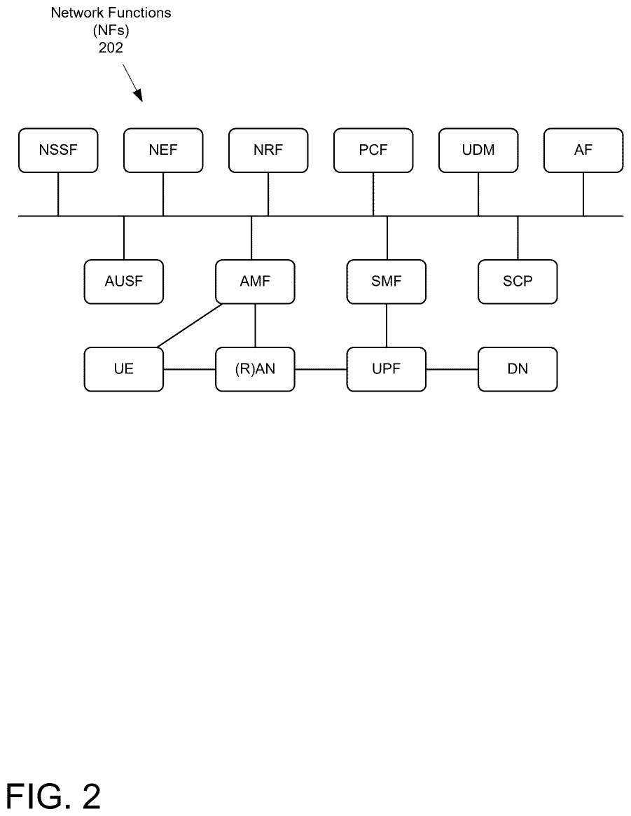

In some examples, the core network 104 can represent a service-based architecture that includes multiple types of network functions that process control plane data and/or user plane data to implement services for the UE 114. In some examples, the services comprise rich communication services (RCS), a VoNR service, a ViNR service, and the like which may include a text, a data file transfer, an image, a video, or a combination thereof. The network functions of the core network 104 can include an Access and Mobility Management Function (AMF), a Session Management Function (SMF), a User Plane Function (UPF), a Policy Control Function (PCF), and/or other network functions implemented in software and/or hardware, just to name a few. Examples of network functions are also discussed in relation to FIG. 2, and elsewhere.

FIG. 2 depicts an example system architecture for a fifth generation (5G) telecommunication network. In some examples, the 5G telecommunication network can comprise the core network 104 in FIG. 1 that includes a service-based system architecture in which different types of network functions (NFs) 202 operate alone and/or together to implement services. Standards for 5G communications define many types of NFs 202 that can be present in 5G telecommunication networks (e.g., the 5G core network), including but not limited to an Authentication Server Function (AUSF), Access and Mobility Management Function (AMF), Data Network (DN), Unstructured Data Storage Function (UDSF), Network Exposure Function (NEF), Network Repository Function (NRF), Network Slice Selection Function (NSSF), Policy Control Function (PCF), Session Management Function (SMF), Unified Data Management (UDM), Unified Data Repository (UDR), User Plane Function (UPF), Application Function (AF), User Equipment (UE), (Radio) Access Network ((R)AN), 5G-Equipment Identity Register (5G-EIR), Network Data Analytics Function (NWDAF), Charging Function (CHF), Service Communication Proxy (SCP), Security Edge Protection Proxy (SEPP), Non-3GPP InterWorking Function (N3IWF), Trusted Non-3GPP Gateway Function (TNGF), and Wireline Access Gateway Function (W-AGF), many of which are shown in the example system architecture of FIG. 2.

One or more of the NFs 202 of the core network 104 can be implemented as network applications that execute within containers (not shown). The NFs 202 can execute as hardware elements, software elements, and/or combinations of the two within telecommunication network(s), and accordingly many types of the NFs 202 can be implemented as software and/or as virtualized functions that execute on cloud servers or other computing devices. Network applications that can execute within containers can also include any other type of network function, application, entity, module, element, or node.

The core network 104 can, in some examples, determine a connection between an IMS that manages a communication session for the device, including sessions for short messaging, voice calls, video calls, and/or other types of communications. For example, the device and the IMS of the telecommunications system 102 can exchange Session Initiation Protocol (SIP) messages to set up and manage individual communication sessions. Different types of communications can, in some examples, utilize different communication channels which can be associated with different network element settings such as different power output by the network element and subsequently the device.

Though some examples in FIG. 1 and elsewhere are described in association with a 5G telecommunication system, the techniques described herein can be used in other telecommunication system types include past generation and/or future generation telecommunication systems.

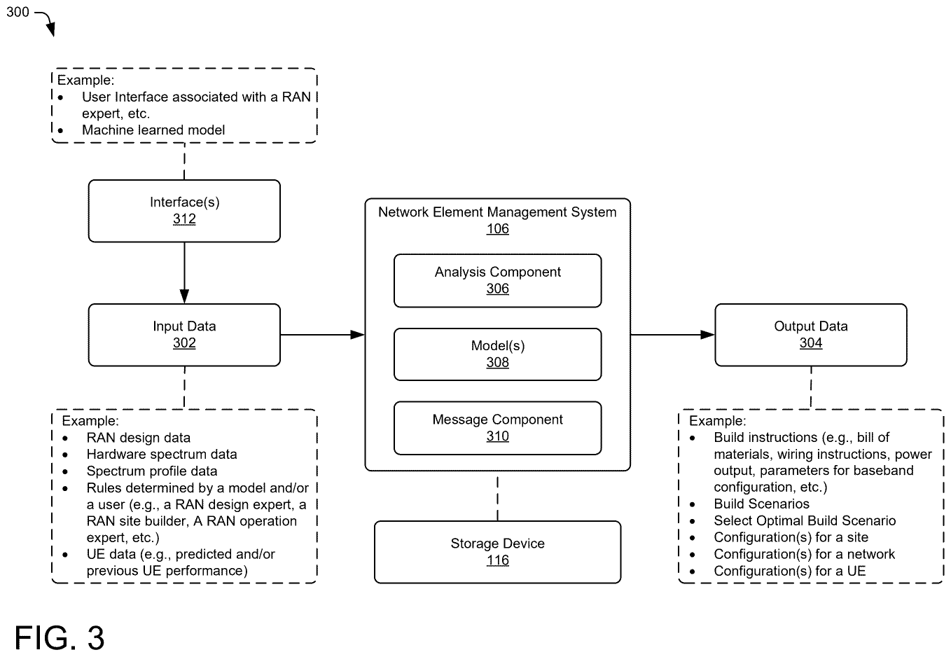

FIG. 3 depicts a block diagram 300 of an example network element management system to implement the techniques described herein. For example, the network element management system 106 of FIG. 1 can receive input data 302 and determine output data 304 using one or more of: an analysis component 306, one or more models 308, and a message component 310. FIG. 3 further depicts the storage device 116 of FIG. 1 for storing input data and/or output data associated with the network element management system 106 coverage data for the core network(s) 104, rules or metadata for network elements, etc. In various examples, the network element management system 106 can represent an AI system (e.g., an expert system that designs, builds, and/or operates a network element). In some examples, the AI system can comprise or otherwise represent a machine learning model(s) configured to perform at least some of the techniques described herein (e.g., the model 308 comprises a machine learning model).

As shown in FIG. 3, the network element management system 106 includes the analysis component 306, the model(s) 308, and the message component 310. Though the analysis component 306, the model(s) 308, and the message component 310 are illustrated in FIG. 3 individually, it is understood that the analysis component 306, the model(s) 308, and the message component 310 (or functionality provided therefrom) may be directly coupled to and/or integrated into a single component or computing device (including in some examples the UE 114 or another device).

The input data 302 can represent RAN design data, RAN build data, RAN operation data, hardware spectrum data, spectrum profile data, and/or rules for a network element (or equipment thereof), among others. The RAN design data can indicate a physical arrangement or architecture for hardware used to provide service as part of the core network(s) 104. The build data and the operational data can represent information usable for building and operating a new or existing network element. Hardware spectrum data can include various types of equipment located at, or deployable to, the network element 108. Spectrum profile data can include one or more spectrum profiles. The spectrum profile can specify radio frequencies that are usable for wireless communication, bands (e.g., low, medium, high, or the like) for providing the frequencies, among others. Changes in spectrum enables a telecommunication system to make corresponding changes in data, voice, and/or video communications between devices.

The input data 302 can also or instead include rules for the network element 108. The rule(s) can indicate, for example, a limitation of a radio such as watts per MHz, watts per transmission channel, watts per band, and/or total watts for the network element, etc. The rule may also or instead indicate a number of frequency blocks for a particular band, a cell site type, hardware, firmware, and/or software used at the cell site (e.g., duplex type such as time division duplex or frequency division duplex), a maximum number of cells, a number of sectors, and/or limits for various equipment types (e.g., 4 cells at ≤20 MHz, 6 cells at ≤100 MHz, etc.). The input data 302 can indicate a limitation or a requirement for a RAN architecture and/or indicate coverage information for the network element (e.g., a number of frequency bands, power output, etc.).

The network element management system can also or instead receive UE data as part of the input data 302. The UE data can, for example, indicate performance by a UE (e.g., the UE 114) using previous configurations for connecting to equipment associated with a network element. The UE data (or data associated with a user thereof) can be received from the UE, a Unified Data Management (UDM), an Authentication Server Function (AUSF), or a Home Subscriber Server (HSS), depending on examples. In some examples, the UE data can indicate an authorization status, UE behavior, UE performance, etc. The UE data may represent predicted UE performance at a future time associated with current output data and/or previous UE performance associated with previous output data.

In various examples, the input data 302 can be received from one or more interfaces 312 (may also be referred to as the interface 312 or the interfaces 312) associated with a user or a model. For example, the interface 312 can represent a user interface of a RAN design expert, a RAN build expert, a RAN operational expert, or the like. Additionally, or alternatively, the interface 312 can represent a machine learning model that provides at least some input data such as a rule for evaluating possible arrangements between radios, carriers, and bands of the network element. The rule can indicate which type of equipment can be used if the network element is upgraded with new hardware, a maximum number of cells or specific frequency bands supported by the new hardware, power to operate the new hardware, etc.

The output data 304 can represent build instructions (e.g., bill of materials, wiring instructions, power output, parameters for baseband unit(s), etc.) for one or more build scenarios. Each build scenario can include different configuration data for the network element 108 to add or remove spectrum. The system 106 can implement the analysis component 306 and/or the model(s) 308 to select an optimal build scenario based on a variety of criteria including, for example, that maximizes a design objective (e.g., fewest architectural changes to add spectrum, prioritize using existing equipment, identify which of multiple equipment to replace, etc.), a build objective (e.g., little or no human involvement to implement the build), and an operational objective (e.g., add the spectrum at a lowest cost and/or least amount of time).

The output data 304 can also or instead indicate configuration data for a network element such as a cell site, a network, and/or a UE. Configuration data for a cell site can, for example, include instructions for arranging, designing, building, and/or connecting equipment within an area of the cell site. The output data 304 can include configuration data for setting up or modifying a network (e.g., a radio access network or other network type). In some examples, the output data 304 can indicate configuration data for a UE that improves operation of the equipment at a particular network element and/or improves operation of the UE (e.g., saves computational resources, battery, etc. over time). For example, the UE may represent a node in a communication channel between the cell site and another UE and the configuration data (e.g., settings or parameters) can cause pre-determined behavior by the UE that improves operation of the UE and/or the equipment at the cell site (relative to not using the configuration data.

In some examples, the system 106 can generate the output data to optimize frequency band assignments to baseband units to reduce a number of physical or virtual connections required to add a new frequency band to the network element infrastructure. The system 106 may also or instead save an amount of time to configure the network element to support a new frequency range) by generating wiring instructions as part of the output data (e.g., determined in seconds rather than hours by a RAN expert). The analysis component 306 can, for example, analyze potential assignments between frequency bands and various baseband units. For example, the analysis component 306 can perform a simulation or a virtual scenario to determine performance of the network element using the potential build scenarios. The analysis component 306 can determine a value indicative of network element performance for each of the build scenarios based on adherence to the set of rules (e.g., a higher performance value for a build scenario meeting a highest number of the rules). The set of rules can include an equipment rule, an operational rule, a design rule, and so on, and the different rules can be “weighted” or hierarchical when determining adherence to a particular rule.

In some examples, the analysis component 306 can output parameters or settings for the network element 108 to add spectrum to the network element 108. The analysis component 306 may determine parameters that operate or control a frequency range, a baseband (e.g., number of cells), power output, a tilt angle, or other characteristics of the network element 108.

In various examples, the model(s) 308 that may be representative of machine learning models, non-machine learning models, or a combination thereof. As described herein, a model may refer to a machine learning model that learns from a training data set to improve accuracy of an output (e.g., a prediction). Additionally or alternatively, a model may represent logic and/or mathematical functions that generate approximations which are usable to make predictions (e.g., a heuristic model, a statistical model, etc.).

In some examples, the model(s) 308 can select an optimal configuration from a set of configurations output by the analysis component 306. For instance, the model(s) 308 can represent a machine learning model that is trained to select one of the set of configurations that optimizes resources (e.g., computational, cost, etc.) available to the network element 108 over time and to use the configuration to add spectrum for the UE 114.

In various examples, the model(s) 308 may generate one or more rules for use as the input data 302. For example, the model(s) 308 can represent a machine learning model that is trained to determine a new rule based on a set of rules received as training data. A RAN designer, operational expert, and/or build expert can provide rules to the machine learning model for training and a trained machine learning model can identify a new rule for the analysis component 306 to consider when determining the output data 304.

In some examples, the network element management system 106 can include a first model for generating rules for use as part of the input data 302 and a second model for generating the output data 304. One of the first model or the second model can represent a machine learning model while the other of the other of the first model or the second model can represent a heuristic model. For example, the second model of the model(s) 308 can comprise a machine learning model trained to generate the output data 304 (e.g., configuration data for a cell site, a network, and/or a UE). The first model and the second model can, for example, represent portions of an AI system.

The message component 310 can provide functionality to transmit (e.g., send and/or receive) a message between a component, model, or UE associated with the telecommunications system 102. The network element management system 106 (or a model or component thereof) can implement the message component 310 to receive the input data 302 from the interface(s) 312, the storage device 116, or other source. In some examples, the message component 310 can send and/or receive messages between a) components and/or models of the network access management system, b) other components and models of the telecommunications system 102, or c) the UE 114 of FIG. 1. In some examples, the message component 310 can exchange the output data 304 with a UE to configure the UE for use with different network elements (e.g., as an intermediate node and/or as an end-user).

In various examples, output data from the network element management system 106 can be stored in the storage device for access at a later time. For example, the storage device 116 can receive data representing previous output data by the network element management system 106 for storage and make such data available to a component, device, etc. for processing at a later time (e.g., for analysis, training, etc.). The network element management system 106 (or component thereof) may, for example, exchange data with the storage device 116 (e.g., a memory, a database, etc.) to implement the network element management techniques described herein.

In various examples, the network element management system 106 can be coupled to the network element 108 or other portion of the telecommunications system 102. Additionally, or alternatively, the network element management system 106 can be centrally located and represent a server or other computing device.

FIG. 4 depicts another block diagram 400 of an example network element management system to implement the techniques described herein. For example, the network element management system 106 of FIG. 1 can provide at least some of the output data 304 to a remote switch 402 and/or to a candidate configuration component 404. The remote switch 402 can represent a remote control switch that is configured to control connections between one or more radios 406 and one or more basebands 408 (e.g., a remote control fiber switch for automatically controlling fiber connections). For example, the output data 304 can include fiber connection information (e.g., wiring diagrams, wiring instructions, etc.) for the remote switch 402 to perform independent of requiring human input.

In some examples, the network element management system 106 can implement the message component 310 to send at least some of the output data 304 to the candidate configuration component 404. For example, the candidate configuration component 404 can receive RAN scenarios, or candidate network element configurations, for a network element, and determine optimal configuration data 410. In various examples, the candidate configuration component 404 can select one of the RAN scenarios for use as the optimal configuration data 410 based on various criteria, objectives, etc. In some examples, the optimal configuration data 410 can be sent to the remote switch 402 and/or to the storage device 116.

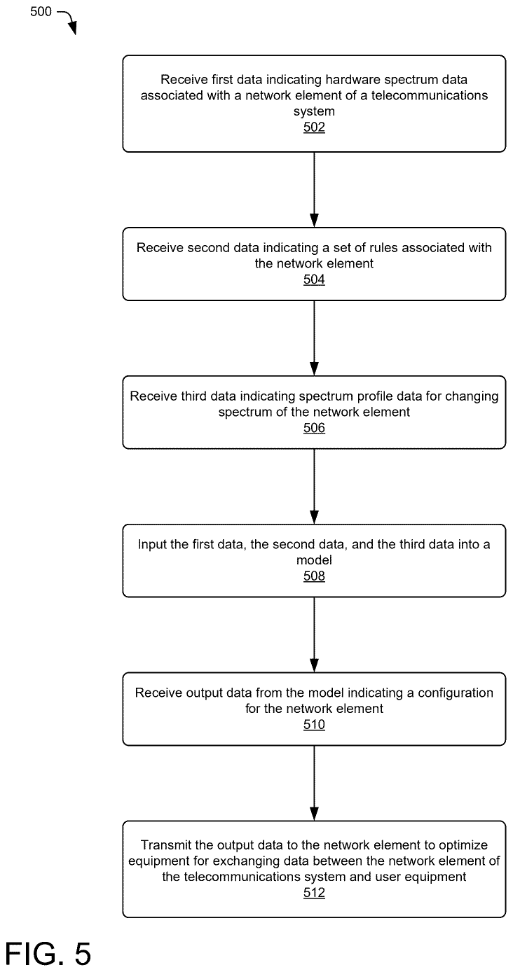

FIG. 5 depicts a flowchart of an example process 500 for determining a configuration for an example network element by an example network element management system. Some or all of the process 500 may be performed by one or more components in FIGS. 1-4, as described herein. For example, some or all of process 500 may be performed by the network element management system 106 of FIG. 1. In some examples, configuration data can be determined for a network element to manage frequency changes provided by the network element.

At operation 502, the process may include receiving first data indicating hardware spectrum data associated with a network element of a telecommunications system. For example, the analysis component 306 can receive hardware spectrum data for one or more network elements associated with a core network (e.g., the core network(s) 104). In some examples, the operation 502 may include the network element management system 106 receiving inventory data indicating hardware, firmware, and/or software operating at respective network elements. In various examples, the inventory data can indicate which frequency bands are usable, and a hardware architecture showing current connections between radio(s), baseband unit(s), or other radio equipment. The network element management system 106 may, for instance, receive the first data from a computing device coupled to the network element, a centrally located computing device, or from a storage device (e.g., the storage device 116). The configuration data can cause the network element to establish or maintain a voice, video, and/or text communication session with the UE 114. In some examples, the network element can represent a base station for providing service based on the input data 302.

At operation 504, the process may include receiving second data indicating a set of rules associated with the network element. For instance, the network element management system 106 can receive some of the input data 302 from the interface(s) 312, the storage device 116, a model, and/or a component. In some examples, an AI system (e.g., a machine learning model, an expert system, or the like) or an interface associated with a user responsible for designing, building, or operating the network element can generate at least some of the second data. The set of rules can include a rule for connecting different types of hardware that collectively enable an exchange of data with the UE 114, for example. The set of rules may also or instead indicate a capability, a requirement, or a limitation of a piece of equipment (e.g., a maximum power output, compatible frequencies bands, etc.).

At operation 506, the process may include receiving third data indicating spectrum profile data for changing spectrum of the network element. In some examples, the operation 506 may include the network element management system receiving a spectrum profile for one or more network elements indicating spectrum to add or remove in the future. The third data can identify desired radio frequencies for adding to the one or more network elements, for instance.

At operation 508, the process may inputting the first data, the second data, and the third data into a model. The model(s) 308 of the network element management system 106 can, for example, process the hardware spectrum data, the set of rules associated with the network element, and the spectrum profile data. In various examples, the network element management system 106 can implement the model(s) 308 (e.g., a heuristic model) to compare the first data, the second data, and the third data.

At operation 510, the process may include receiving output data from the model indicating a configuration for the network element. For example, the model(s) 308 can output configuration information (e.g., the output data 304) for operating the one or more network elements. The output data can include a wiring schematic, equipment list, costs associated with the configuration, and so on.

At operation 512, the process may include transmitting the output data to the network element to optimize equipment for exchanging data between the network element of the telecommunications system and user equipment. In some examples, the operation 512 may include the network element management system 106 implementing the message component 310 to transmit a message with the configuration information (e.g., computer-readable instructions, etc.) for the network element 108. The output data generated by the network element management system 106 can include one or more settings or parameters for modifying a remote switch (e.g., the remote switch 402), a mechanical tilt angle, an electronic tilt angle, power output, frequency band, baseband unit, or the like of the network element 108.

FIG. 6 depicts an example system architecture for the UE 114, in accordance with various examples. As shown, a UE 114 can have memory 602 storing a call setup manager 604, and other modules and data 606. The UE 114 can also comprise processor(s) 608, radio interfaces 610, a display 612, output devices 614, input devices 616, and/or a machine readable medium 618.

In various examples, the memory 602 can include system memory, which may be volatile (such as RAM), non-volatile (such as ROM, flash memory, etc.) or some combination of the two. The memory 602 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the UE 114. Any such non-transitory computer-readable media may be part of the UE 114.

The call setup manager 604 can send and/or receive messages comprising a VoNR service, a ViNR service, and/or an RCS service including SIP messages associated with setup and management of a call session via an IMS, an AMF, or the like. The SIP messages can include an SIP INVITE message and/or other SIP messages.

The other modules and data 606 can be utilized by the UE 114 to perform or enable performing any action taken by the UE 114. The modules and data 606 can include a UE platform, operating system, and applications, and data utilized by the platform, operating system, and applications.

In various examples, the processor(s) 608 can be a central processing unit (CPU), a graphics processing unit (GPU), or both CPU and GPU, or any other type of processing unit. Each of the one or more processor(s) 608 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 608 may also be responsible for executing all computer applications stored in the memory 602, which can be associated with common types of volatile (RAM) and/or nonvolatile (ROM) memory.

The radio interfaces 610 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the radio interfaces 610 can be compatible with multiple radio access technologies, such as 5G radio access technologies and 4G/LTE radio access technologies. Accordingly, the radio interfaces 610 can allow the UE 114 to connect to a 5G system and/or a 4G system (or other past or future system) as described herein.

The display 612 can be a liquid crystal display or any other type of display commonly used in UEs. For example, display 612 may be a touch-sensitive display screen, and can then also act as an input device or keypad, such as for providing a soft-key keyboard, navigation buttons, or any other type of interactive input. In some examples, the display 612 can represent a wearable device such as a headset for presenting and/or receiving data associated with a user. The output devices 614 can include any sort of output devices known in the art, such as the display 612, speakers, a vibrating mechanism, and/or a tactile feedback mechanism. Output devices 614 can also include ports for one or more peripheral devices, such as headphones, peripheral speakers, and/or a peripheral display. The input devices 616 can include any sort of input devices known in the art. For example, input devices 616 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 618 can store one or more sets of instructions, such as software or firmware, that embodies any one or more of the methodologies or functions described herein. The instructions can also reside, completely or at least partially, within the memory 602, processor(s) 608, and/or radio interface(s) 610 during execution thereof by the UE 114. The memory 602 and the processor(s) 608 also can constitute machine readable media 618.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### Conclusion

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving first data indicating hardware spectrum data associated with a network element of a telecommunications system;
receiving second data indicating a set of rules associated with the network element;
receiving third data indicating spectrum profile data for changing spectrum of the network element;
inputting the first data, the second data, and the third data into a model;
receiving output data from the model indicating a configuration for the network element; and
transmitting the output data to the network element to optimize equipment for exchanging data between the network element of the telecommunications system and user equipment.

2. The method of claim 1, wherein:
the network element comprises a radio access network,
the configuration comprises one or more of: a bill of materials, wiring instructions for the equipment, a site name, maximum power, or a baseband configuration, and
the set of rules associated with the network element indicates a requirement or a limitation of one or more frequency bands provided the network element.

3. The method of claim 1, further comprising:
receiving, from the model and as intermediate output data, a set of radio access network scenarios;
evaluating the set of radio access network scenarios; and
selecting a radio access network scenario from the set of radio access network scenarios as the output data.

4. The method of claim 1, further comprising:
determining at least one rule of the set of rules by an artificial intelligence (AI) system trained to predict a rule for configuring the network element.

5. The method of claim 1, wherein:
the spectrum profile data includes a request to add spectrum to the network element, and
the configuration includes settings for the network element to add the spectrum.

6. The method of claim 1, further comprising:
receiving the second data or the third data from a user interface associated with a user responsible for designing, building, or operating the network element.

7. The method of claim 1, wherein:
the output data indicating the configuration for the network element comprises instructions for a remote control fiber switch configured to control fiber connections between a radio of the network element and a baseband of the network element.

8. A system comprising:
one or more processors; and
memory storing computer-executable instructions that, when executed by the one or more processors, cause the system to perform operations comprising:
receiving first data indicating hardware spectrum data associated with a network element of a telecommunications system;
receiving second data indicating a set of rules associated with the network element;
receiving third data indicating spectrum profile data for changing spectrum of the network element;
inputting the first data, the second data, and the third data into a model;
receiving output data from the model indicating a configuration for the network element; and
transmitting the output data to the network element to optimize equipment for exchanging data between the network element of the telecommunications system and user equipment.

9. The system of claim 8, wherein:
the network element comprises a radio access network, and
the configuration comprises one or more of: a bill of materials, wiring instructions for the equipment, a site name, maximum power, or a baseband configuration.

10. The system of claim 8, the operations further comprising:
receiving, from the model and as intermediate output data, a set of radio access network scenarios;
evaluating the set of radio access network scenarios; and
selecting a radio access network scenario from the set of radio access network scenarios as the output data.

11. The system of claim 10, wherein:
selecting the radio access network scenario is performed by an artificial intelligence (AI) system trained to evaluate the set of radio access network scenarios based on one or more criteria.

12. The system of claim 8, wherein:
the spectrum profile data includes a request to add spectrum to the network element, and
the configuration includes settings for the network element to add the spectrum.

13. The system of claim 8, the operations further comprising:
receiving the second data or the third data from a user interface associated with a user responsible for designing, building, or operating the network element.

14. The system of claim 8, wherein:
the set of rules indicates one or more of: a limitation of the equipment, a requirement of the equipment, a processing capability of the equipment, baseband information, or radio information.

15. The system of claim 8, wherein:
the set of rules indicate one or more of: watts per MHz, watts per transmission channel, watts per band, or total watts.

16. One or more non-transitory computer-readable media storing instructions executable by one or more processors, wherein the instructions, when executed, cause the one or more processors to perform operations comprising:
receiving first data indicating hardware spectrum data associated with a network element of a telecommunications system;
receiving second data indicating a set of rules associated with the network element;
receiving third data indicating spectrum profile data for changing spectrum of the network element;
inputting the first data, the second data, and the third data into a model;
receiving output data from the model indicating a configuration for the network element; and
transmitting the output data to the network element to optimize equipment for exchanging data between the network element of the telecommunications system and user equipment.

17. The one or more non-transitory computer-readable media of claim 16, wherein:
the network element comprises a radio access network,
the configuration comprises one or more of: a bill of materials, wiring instructions for the equipment, a site name, maximum power, or a baseband configuration, and
the set of rules associated with the network element indicates a requirement or a limitation of one or more frequency bands provided the network element.

18. The one or more non-transitory computer-readable media of claim 16, the operations further comprising:
receiving, from the model and as intermediate output data, a set of radio access network scenarios;
evaluating the set of radio access network scenarios; and
selecting a radio access network scenario from the set of radio access network scenarios as the output data.

19. The one or more non-transitory computer-readable media of claim 16, the operations further comprising:
determining at least one rule of the set of rules by an artificial intelligence (AI) system trained to predict a rule for configuring the network element.

20. The one or more non-transitory computer-readable media of claim 16, the operations further comprising:
receiving the second data or the third data from a user interface associated with a user responsible for designing, building, or operating the network element.
